(19) United States
(12) Patent Application Publication
(10) Pub. No.: US 2010/0050388 A1
(43) Pub. Date: Mar. 4, 2010

(54) Molded Hinge Article for a Side-Loading Refuse Vehicle and Method of Making

(75) Inventors: Kevin M. Shaber, Rochester, MN (US); Thomas G. Lindblom, Claremont, MN (US)

Correspondence Address: NIKOLAI & MERSEREAU, P.A., 900 SECOND AVENUE SOUTH, SUITE 820, MINNEAPOLIS, MN, 55402, US

(73) Assignee: MCNEILUS TRUCK AND MANUFACTURING, INC., Dodge Center, MN (US)

(21) Appl. No.: 12/204,241

(22) Filed: Sep. 4, 2008

(51) Int. Cl. E05D 7/00; B29C 45/14

(52) U.S. Cl. 16/385; 264/257; 16/221

(57) ABSTRACT

The present development provides a continuous fiber reinforced elastomeric resin molded article which may be exemplified by a flexible hinge used in the hostile environment of a refuse collection vehicle.

The present development also provides an advanced molding process for making fiber-reinforced elastomeric composite molded articles. The process is particularly useful for articles that include areas of flexure and point loading.

### CROSS-REFERENCED TO RELATED APPLICATIONS

Not applicable

### STATEMENT REGARDING FEDERALLY SPONSORED RESEARCH OR DEVELOPMENT

Not applicable

### BACKGROUND OF THE INVENTION

I. Field of the Invention

The present invention relates generally to a process for making molded fiber reinforced composite articles in generally sheet form having tailored properties such as increased fiber reinforcement surrounding point-loaded features such as openings to accommodate fastening devices and to a process for forming such articles that provides continuous fiber reinforcement around fastener openings. The development further relates to the use of such an article as a continuous flexible hinge for fastening a follower member to a compacting panel in side-loading or front-loading rear-discharging refuse vehicles with charging areas that include low profile packer panel systems with attached hinged follower panels. These systems typically receive refuse loaded by mechanized-container handling equipment.

II. Related Art

Refuse hauling vehicles commonly include a heavy-duty chassis including a forward cab and a separately manufactured truck body mounted on the chassis and dedicated to receiving, compacting, hauling and discharging refuse materials. The truck body generally includes all the associated hydraulic, pneumatic and/or electrical operating mechanisms associated with heavy-duty packing and ejection equipment. In front or side-loading systems, a charging or receiving hopper or section is provided behind the cab and forward of the storage volume to accept deposited refuse. The receiving section further contains a packing system for packing deposited refuse rearward into a storage enclosure. As indicated, the receiving area or section is located behind the truck cab and refuse to be hauled is loaded into the receiving area as by tipping containers, either manually, with a cart tipper or using a mechanized container handling system which, in the case of a side-loading vehicle, is mounted on one side of the charging hopper or to the truck chassis. Thus, loading of the charging area is accomplished through side openings or an open top. The packing system includes a reciprocating ram, usually hydraulically operated, which compacts the material moving it rearward into the storage compartment where it is eventually compacted against a heavy-duty tailgate, normally in the convex shape of a pressure vessel.

Thus, front or side-loading refuse vehicle bodies include packing and ejecting mechanisms that pack refuse from a charging area or section rearward into an associated hollow storage enclosure. The body is usually designed to be tipped to fully eject the refuse from the storage enclosure, but the mechanism may be designed to eject refuse fully without tipping. Container emptying pivoting frontal fork arms are provided on front loading systems and mechanized lifting and emptying apparatus situated on one side of the receiving hopper typify side loaders to engage and empty containers of interest into corresponding receiving or charging areas. A side-loading apparatus typically includes a holding or grasping device generally connected to an arm or extensible boom which is connected, in turn, to a base mounted on the vehicle. The arm or boom and grasping device are operated in concert to engage a container of interest, lift and dump the container into the receiving hopper in the vehicle. Such systems are typically operated using one or more hydraulic devices to extend or retract the boom, pivot the arm and open and close the grabbing device. Examples of such booms are shown in U.S. Pat. Nos. 5,657,654; 5,769,592; and 5,931,628.

It is further known to provide side loading refuse collection truck bodies that are manually loaded, have cart tipper or automatic loading devices, or combine or accommodate both manual and automated-type container loading abilities.

The process of emptying containers can cause refuse to be deposited behind the packer panel if the packer panel is advanced to a rearward location. To prevent this from occurring, packer panel systems have also been provided with hinged follower members that extend across the charging area and enable the loading of refuse to proceed with the packer panel in any position, including a fully extended packing position. The follower members extend to the front of the charging area and are connected to the packer panel by elongate hinges. Existing followers have been connected to the packer panel by steel hinges which extend across the width of the follower and allow the follower to swing or pivot upward when it encounters the forward wall of the refuse body as the packer panel is retracted. The followers also typically include end rollers to engage the forward wall of the refuse body.

Metal hinges, particularly steel hinges, all suffer from a shortened useful life due to the hostile refuse environment. They are subject to both clogging, abrasion and corrosion problems. Thus, a need has existed for an unimpaired follower hinge construction that is impervious to clogging and the abrasive and corrosive materials that shorten the useful life of conventional steel or other metal hinges.

Processes exist to mold elastomeric materials in sheet form containing fiber reinforcement materials to produce composite articles. Known molding processes and techniques include reaction injection molding and compressed fiber resin transfer molding. These processes are performed in many variations and with many methods of locating and distributing fiber within the molded article; but all these methods are limited by the need to stack or otherwise fill a mold with various fillers or the like to locate specific reinforcements at specific locations in the cross-section. Point-load features such as fastener openings or bolt holes incorporated in molded articles have presented particular problems with respect to achieving necessary surrounding fiber reinforcement. If a point-loaded feature, such as a bolt hole has to be incorporated in a fiber-reinforced composite molded article, the reinforcing material is either normally cut prior to molding or the feature is machined in later. This removes a portion of the reinforcing fiber from the vicinity of the point-load location and thereby compromises the effect of the reinforcement at a point where it is least desirable. Thus, there exists a definite need to better accommodate local stress concentrations in fiber reinforced composite molded articles.

A particular need exists with respect to articles which require flexure such as hinges, the operation of which continually stress points of support such as the areas of fasteners. It would be a particular advantage to provide a relatively uncomplicated process to accomplish increased point-load fiber reinforcement.

### SUMMARY OF THE INVENTION

The present development provides, in one aspect, a continuous fiber reinforced elastomeric resin molded article which may be exemplified by a flexible hinge. The hinge of the illustrative embodiment is one used in the hostile environment of a refuse collection vehicle. The hinge is fastened to both a packer panel and an associated follower panel member. The hinge construction enables continuous stress flow around point loads (here bolt holes) and maintains, at the same time, all of the physical property advantages of a molded reinforced elastomeric composite article. The hinge is inert to the hostile environment and has none of the limitations of earlier metal hinges.

In another aspect, the present development provides an advanced molding process for making fiber-reinforced elastomeric composite molded articles. The process is particularly useful for articles that include areas of flexure and point loading. The process features suspending a layer of fiber reinforcing material in a mold section containing a pattern of protruding features which define areas of point loading, namely, for example, openings for fasteners such as bolt holes, or the like. The protruding features are used to support one or more layers of a fabric structure of fiber reinforcing materials at any desired level within the mold structure. Casting of the matrix polymer material for the composite is accomplished with the reinforcing fiber layer or layers located as desired without the need for fillers or spacers. The matrix material of the composite is thereafter cast into the mold and the composite is cured. The cure may take place at room temperature or slightly elevated temperatures such as 150° F. (65° C.) if it is desired to accelerate the cure. The process enables the molding of features such a bolt holes into a composite article with no interruption in fiber continuity.

Whereas other materials may be used to form the composite in accordance with the present development, one preferred type of fiber material includes aromatic polyamides, or aramides, which are fibrous materials marketed under the trademark Kevlar® (trademark of the DuPont Corporation). These fibers are preferably combined with one or more polyurethane matrix materials to form a composite article having unique desirable properties.

### BRIEF DESCRIPTION OF THE DRAWINGS

In the drawings:

FIG. 1 is a schematic perspective view of a refuse hauling vehicle with an automated side-loading, rear-discharging packer body including a packing system utilizing a follower with a conventional prior art hinge shown with tailgate removed;

FIG. 2 is a fragmentary schematic perspective view of a packer arrangement as in FIG. 1 with a container handling device and follower utilizing a prior hinge shown with the packer panel fully extended in the packing position and a cart in the fully tipped position;

FIG. 3 is a fragmentary schematic perspective view similar to FIG. 2 with the container handling device stowed, the packer panel fully retracted and the follower in the raised disposition;

FIG. 4a is a schematic perspective view of a combined packer panel/follower coupled utilizing a hinge in accordance with the present invention;

FIG. 4b is a fragmentary enlarged view of the composite hinge of FIG. 4a; and

FIGS. 5a-5c are plan, elevation (cross-section) and perspective views of a section of a mold for making the composite hinge of the invention.

### DETAILED DESCRIPTION

The present development provides a molding process or technique and composite articles fabricated using the process or technique. The process enables tensile strength, elongation and other desired characteristics determined by reinforcing fibers to be established prior to molding by suspending one or more designed reinforcing fiber layers at a desired level in a mold structure prior to the introduction of composite matrix material or binder.

The suspended reinforcing fiber molding process features one or more layers of fiber reinforcement utilizing a continuous fiber fabric structure capable of being handled as an independent layer. The suspended fiber layers are typically supported in the mold by devices that define features to be molded into the final article such as protrusions (pegs or posts) which determine openings for fasteners such as bolt holes, or the like. However, the fiber layers may be suspended in any desired manner so long as the proper support is available. Once the fiber layers are located at the desired level in the mold, an elastomer or resin matrix can be introduced to any desired thickness on either side to form the part to be molded. Typically, this will produce a smooth surfaced, reinforced article in which desired fiber reinforcements surround point-loaded features, such as bolt holes, and in which the reinforcing of fibers impart the desired mechanical attributes to the article. It will be appreciated that any desired combination of fiber layers and matrix polymers may be utilized in accordance with the process of the invention and that the specific embodiments described herein are meant by way of example and not limitation.

A preferred class of composite materials for a follower hinge example article of the present invention includes those with high impact resistance, high tensile modulus and high flexure modulus, high abrasion and corrosive chemical resistance, as well as very little shrinkage during molding. Although the composites contain fibers, the process of the invention also enables the surface of the molded article to be smooth and fiber-free. While the hinges are molded with a pattern of spaced bolt holes, it should be noted that any desired features may be incorporated in a mold and any suitable means of suspending fiber layers in the mold may also be used.

Based on the directional arrangement of the fibers, generally composite materials exhibit a directional dependent or anisotropy with regard to a variety of properties. In a unidirectional laminate, for example, the higher performance characteristics associated with the fibers prevail in a direction parallel to the fibers and properties perpendicular to the fibers exhibit characteristics that mimic the behavior of the matrix material. Orienting the majority of the fibers as desired enables the tailoring of a fiber layer to produce desired characteristics in the molded structure.

The suspended fiber molding process of the invention enables the creation of a composite article with desired characteristics exemplified by the elastomeric hinge of the present invention which exhibits good bi-axial tensile strengths with low elongation governed by the properties of the fiber reinforcement. The elastomeric hinge also exhibits elastomeric compressive behavior governed primarily by the molded matrix elastomer. The required elastomeric bending behavior of the hinge is governed by the molded elastomer and not constrained by the fiber reinforcement. This is made possible by orienting the fiber reinforcement on the neutral axis of the part.

In this manner, articles can be made with the desired directional characteristics and also with proper reinforcement surrounding point-loaded features. These articles can be made with any desired shape or thickness. The molding process also enables the article to be finished with no post-molding machining operations required. This is especially advantageous as the hard fibers of a composite are highly abrasive and difficult to machine.

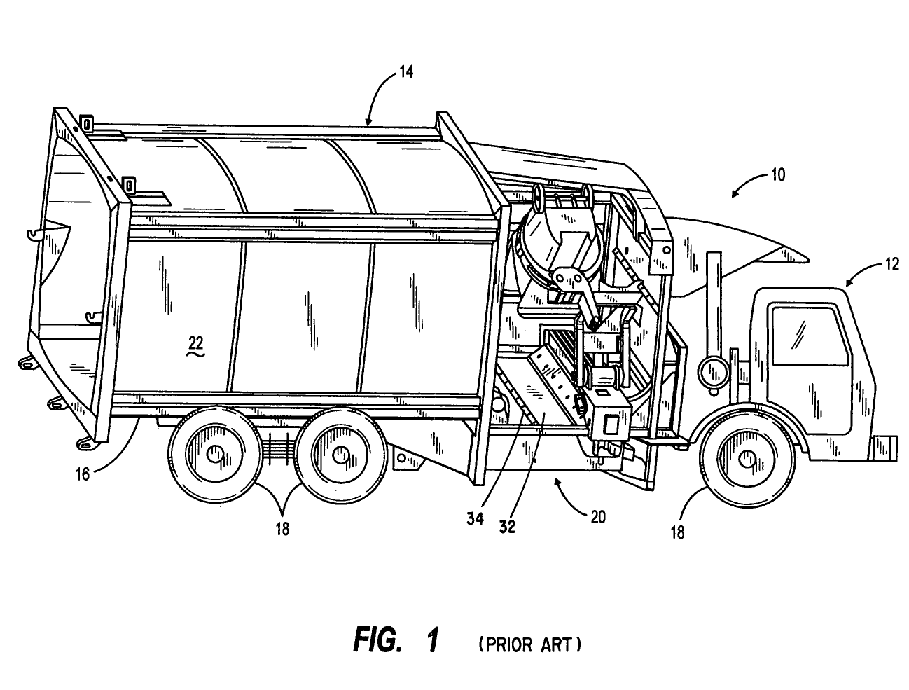

FIGS. 1-3 illustrate a typical refuse vehicle provided with a low profile packer panel with a follower connected by a prior art hinge.

In FIG. 1, there is shown a schematic perspective view of a refuse hauling vehicle, generally at 10, which includes a chassis-mounted cab 12 and a dedicated refuse processing body 14 shown with the tailgate removed. The packer body is mounted on heavy chassis members as at 16 and is carried by a plurality of wheels as at 18. The truck body basically includes a charging or receiving area indicated generally by 20 and a relatively large storage area at 22. In the view illustrated in FIG. 1, the tailgate has been removed showing a portion of the interior of the storage volume 22.

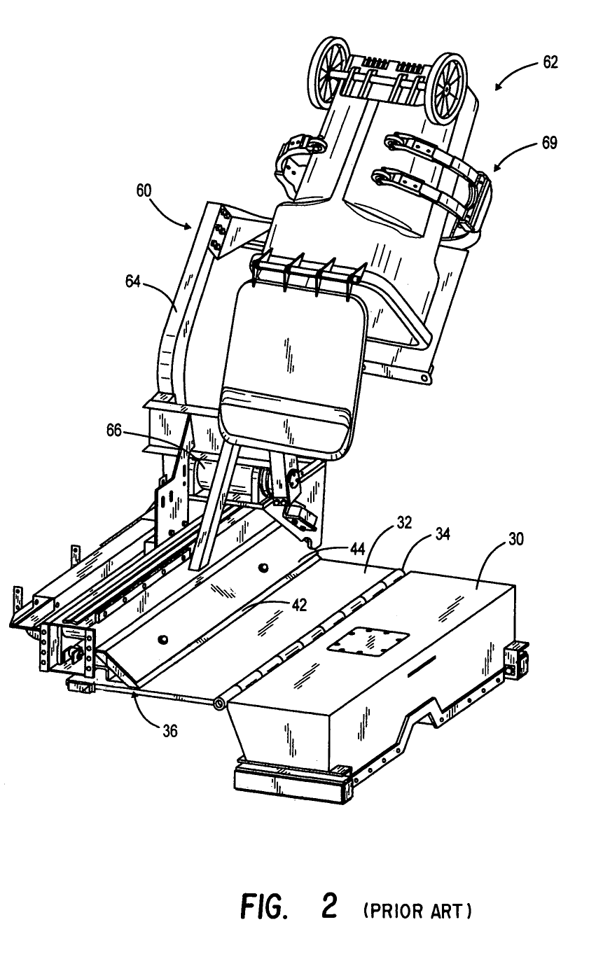

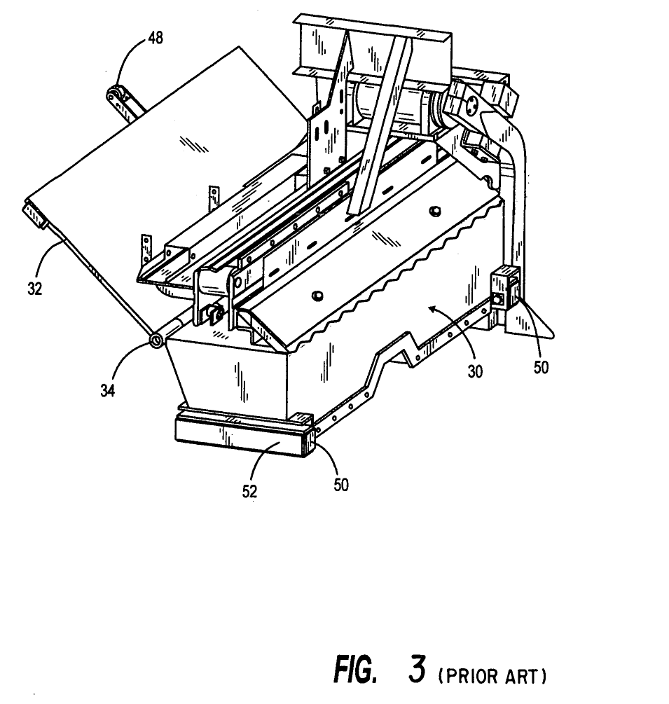

As seen best in FIGS. 2-3, the packing system includes a packer panel 30 with attached follower 32 hinged to the packer panel by a full-width hinge 34. A wiper system is shown at 36 and includes wiper blade member 42 and a wiper guard member 44. A roller device 48 (FIG. 3) is attached to the end of the follower panel to engage the front wall of the truck body and guide the panel in its upward pivoting path as the packer panel is retracted. The packer panel is supported by and travels on a pair of spaced packer rider members (bars or tubes) 50 which include top, bottom and side wear surfaces (plates or strips) as at 52 and which ride in a rail system on each side of the packer body in a well known manner (not shown).

The side-loading system may include a container handling apparatus 60 (shown in FIG. 2) with a container 62 in an elevating or tipping position. The system includes a pair of lift arms as at 64 operated by a double-ended rotary actuator 66 and includes a container grabber assembly as shown at 69 in FIG. 2. The container grabber assembly may be mounted in an offset position as shown and many types of such devices are available.

FIG. 2 depicts the packer panel in a fully extended or packing position and FIG. 3 shows the system with the packer panel fully retracted and the follower fully pivoted upward.

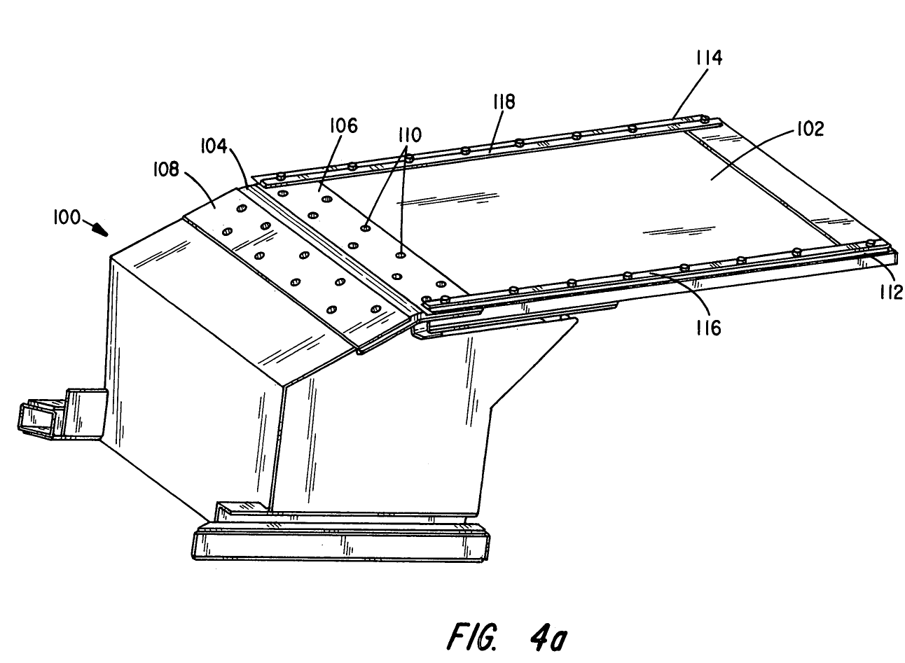

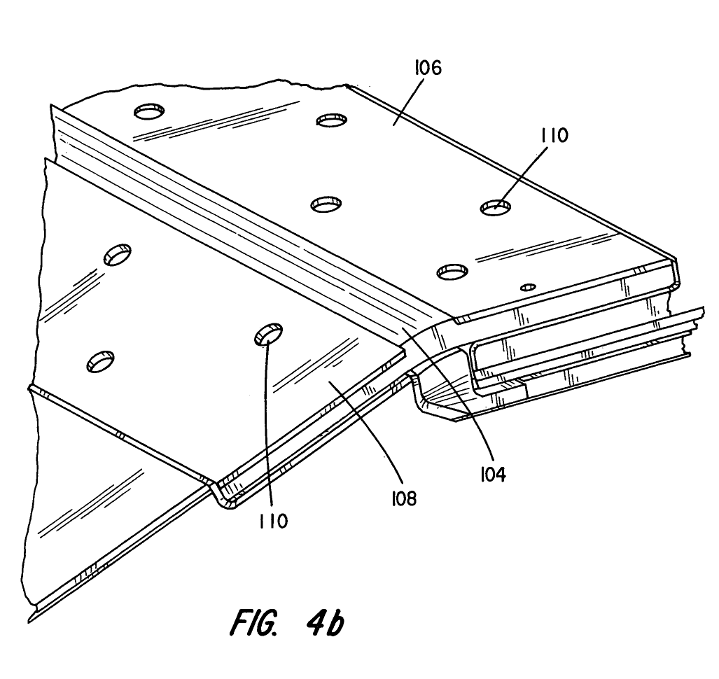

FIG. 4a is a simplified schematic perspective view of a packer panel 100 with attached elongate steel follower panel 102 connected by a composite flexible hinge 104 in accordance with the invention. The system further includes a pair of spaced metal plates 106 and 108 which overlay part of the material of the hinge and hold the hinge in place. The plates are fastened to the packer panel and follower, respectively, through openings as at 110. The follower 112 and 114 panel further includes a pair of rubber wipers that extend along the outside edges and are held in place by steel strips 116 and 118, respectively.

FIG. 4b is a greatly enlarged fragmentary view of the hinge that depicts an array of bolt holes 110 for attaching the hinge 104 to both the follower panel 102 and the packer panel 100. The composite hinge 104 provides necessary strength and flexibility while presenting a sealed, relatively inert surface to refuse contacting the follower.

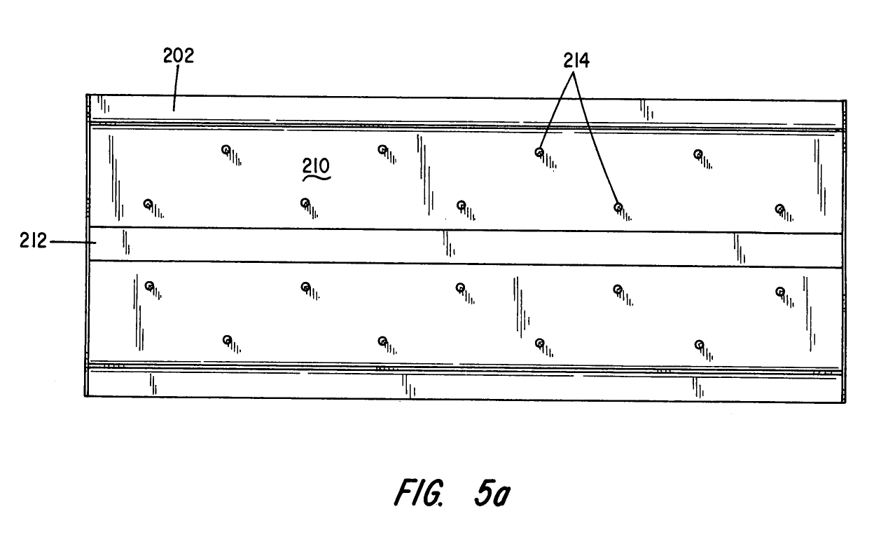

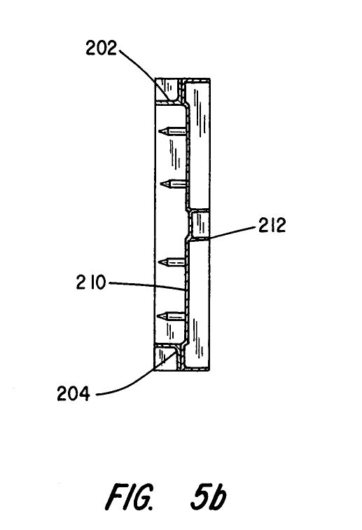

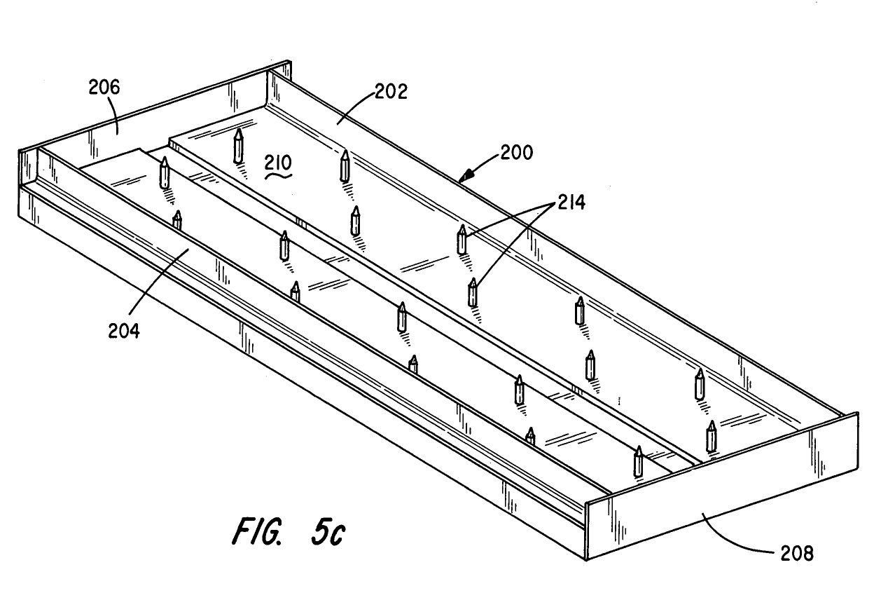

FIGS. 5a-5c depict plan, side elevation (cross-sectional) and perspective views of a typical mold form, generally 200, used to mold an article in accordance with the invention. The form is shown without a top panel and includes a pair of spaced side panels 202 and 204 and spaced end panels 206 and 208. The mold further includes a bottom panel 210 with central reinforcement 212. Protruding pegs or posts 214 represent bolt hole locations in a molded hinge and also support one or more layers of reinforcing fabric (not shown).

While the illustrated mold is generally rectangular, the mold can be of any desired shape or thickness corresponding to an article to be produced. The hinge, for example, must be large enough to cover the width of the packer panel which extends across the entire charging area. The hinge is about ½-1-½ inches thick.

This invention has been described herein in considerable detail in order to comply with the patent statutes and to provide those skilled in the art with the information needed to apply the novel principles and to construct and use embodiments of the example as required. However, it is to be understood that the invention can be carried out by specifically different devices and that various modifications can be accomplished without departing from the scope of the invention itself.

What is claimed is:

1. A method of fabricating a molded fiber-reinforced composite article having a plurality of openings therein comprising:
(a) providing a mold having a form section and a cover, said form section having a width and length and a depth corresponding to dimensions of an article to be fabricated and including a pattern of protruding members or posts corresponding to a pattern of desired point loadings or openings in said article to be fabricated;
(b) inserting a fiber-reinforcement layer into said mold form over said pattern of protruding members which thereby define and incorporate said point loadings or openings in said fiber-reinforcement layer surrounded by said fiber reinforcement layer;
(c) closing said mold and infusing an amount of uncured polymer matrix material into said mold incorporating said fiber-reinforcement layer into said polymer material forming a composite structure;
(d) curing said composite structure in said mold and removing the cured composite articles.

2. A method as in claim 1 wherein said composite article is in the form of a sheet of material.

3. A method as in claim 1 wherein said fiber-reinforcement layer includes a material selected from aromatic polyamides and aramides.

4. A method as in claim 1 wherein said composite matrix material includes a polyurethane.

5. A method as in claim 3 wherein said composite matrix material includes a polyurethane.

6. A method as in claim 1 wherein said curing further comprises adding an amount of heat to the mold.

7. A method as in claim 1 comprising inserting a plurality of fiber-reinforcement layers into said mold form.

8. A method as in claim 1 wherein said fiber-reinforcement layer includes fibers oriented in accordance with desired properties in a finished composite structure.

9. A method as in claim 7 wherein said fiber-reinforcement layer includes fibers oriented in accordance with desired properties in a finished composite structure.

10. A method as in claim 8 wherein said fiber-reinforcement layer includes a material selected from aromatic polyamides and aramides.

11. An article made by the process of claim 1.

12. A follower hinge for a packer panel in a front or side-loading refuse vehicle comprising a molded flexible continuous fiber-reinforced elastomeric resin composite sheet having an array of point load openings having continuous fiber reinforcement around the point load openings.

13. A follower hinge as in claim 12 comprising at least one fiber-reinforcement layer suspended in an elastomer.

14. A follower hinge as in claim 13 wherein said fiber-reinforcement layer includes a material selected from aromatic polyamides and aramides and said elastomeric resin includes a polyurethane.

15. A follower hinge as in claim 13 wherein said fiber-reinforcement layer includes fibers oriented in accordance with desired properties in said hinge.

16. A follower hinge as in claim 14 wherein said fiber-reinforcement layer includes fibers oriented in accordance with desired properties in said hinge.

17. A follower hinge as in claim 12 wherein the point load openings are bolt holes.

18. A follower hinge as in claim 12 wherein said packer panel is mounted in a refuse vehicle body.
